(19) United States
(12) Patent Application Publication
(10) Pub. No.: US 2025/0020586 A1
(43) Pub. Date: Jan. 16, 2025

(54) MODIFICATION OF CELLULOSE-BASED MATERIAL PARTS

(71) Applicant: Teknologian tutkimuskeskus VTT Oy, Espoo (FI)

(72) Inventors: Tapio MÄKELÄ, Espoo (FI); Ari HOKKANEN, Espoo (FI)

(21) Appl. No.: 18/712,140

(22) PCT Filed: Nov. 17, 2022
(86) PCT No.: PCT/FI2022/050760

§ 371 Date: May 21, 2024

(30) Foreign Application Priority Data
Nov. 23, 2021 (FI) 20216197

(51) Int. Cl. G01N 21/47; G01N 21/81

(52) U.S. Cl. CPC G01N 21/4788; G01N 21/81; G01N 2201/12746

(57) ABSTRACT

There is provided detecting modification of optically active cellulose-based film. A method comprises controlling, by a processor, an optical position sensor device to capture data from a first diffraction response formed based on at least one modification of a first cellulose-based material part and a second diffraction response formed based on the at least one modification of a second cellulose-based material part; and determining, by the processor, a reading indicating the at least one modification based on the captured data.

### TECHNICAL FIELD

The present invention relates to modification of cellulose-based material parts that are of different cellulose-based materials.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

Cellulose-based films are biodegradable and transparent. In many applications, the cellulose-based films are exposed to various conditions that may have an adverse effect on the cellulose-based film or to products that close to the cellulose-based film. The various conditions may be left undetected and unnoticed and in such a case also their adverse effects may be left unnoticed. Detection of the conditions is important at least in applications, where reliable product quality is wanted.

### SUMMARY

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect there is provided an apparatus according to the independent claim 1.

According to a second aspect there is provided an arrangement according to the independent claim 7.

According to a third aspect there is provided a method according to the independent claim 15.

According to a fourth aspect there is provided a computer program according to the independent claim 16.

### BRIEF DESCRIPTION OF THE DRAWINGS

For a more complete understanding of example embodiments of the present invention, reference is now made to the following descriptions taken in connection with the accompanying drawings in which:

FIG. 1a, FIG. 1b, FIG. 2a and FIG. 2b illustrate surface patterns accordance with at least some embodiments of the present invention;

FIG. 3 and FIG. 4 illustrate methods in accordance with at least some embodiments of the present invention;

FIG. 5 illustrates change of a surface pattern in accordance with at least some embodiments of the present invention;

FIG. 6 illustrates a block diagram of an arrangement in accordance with at least some embodiments of the present invention; and

FIGS. 7, 8, 9 and 10 illustrate examples of apparatuses configured to form two or more diffraction responses.

### DETAILED DESCRIPTION OF SOME EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

There is provided an apparatus for sensing modifications of cellulose-based materials. The apparatus comprises a first cellulose-based material part for forming a first diffraction response and a second cellulose-based material part for forming a second diffraction response, wherein the first cellulose-based material part and the second cellulose-based material part are of different cellulose-based materials, whereby in response to the at least one modification applied to the sensor, the sensor is configured to form, based on at least one of the first diffraction response and the second diffraction response, at least one output light pattern for characterizing the at least modification. The diffraction response, and/or a change of the diffraction response, may be characteristic to a sensitivity of the cellulose-based material to the at least one modification, which provides sensing the at least modification. The output light pattern is a combination of the diffraction responses of the at least two cellulose-based materials, whereby the at least modification may a cause a change, to one or more of the diffraction responses and the output light pattern. In other words, the at least one modification may cause a change of e.g. a shape, density, dimensions and/or a position of a diffraction response formed by a cellulose-based material part. Therefore, an output light pattern before the at least one modification is applied may be different with respect to the output light pattern of the apparatus after the at least one modification has been applied. The output light pattern or at least the individual diffraction responses may be used to determine a reading. The reading may be a value of a physical quantity. The value may indicate a level, or magnitude of the at least one modification. Each of the diffraction patterns may be used to determine a reading that characterizes the at least one modification. The readings determined based on the diffraction responses may be used to compensate one another. In an example a temperature reading is determined by one diffraction response and a humidity reading is determined by another diffraction response, whereby a temperature compensated humidity reading may be determined based on a relationship of the temperature and the humidity.

A cellulose-based material may be polymeric cellulose, fibrillated cellulose, and/or fiber cellulose, cellulose nanofibril, CNF, preferably TEMPO-oxidized cellulose nanofibril, TEMPO-CNF. A polymeric cellulose material may also be referred to regenerated cellulose-based film. Examples of polymeric cellulose material comprise cellophane or cellulose acetate, CA. Nanofibrillated cellulose may refer to fibrillated cellulose comprising cellulose fibers with nanoscale diameter and a narrow size distribution of the fibers. Similarly, nanofiber cellulose may refer to fiber cellulose comprising cellulose fibers with nanoscale diameter and a narrow size distribution of the fibers. Accordingly, examples of cellulose-based materials comprise cellulose-based films comprising at least a polymeric cellulose film, fibrillated cellulose film, and/or fiber cellulose film, a cellulose nanofibril (CNF) film, a nanofibrillated cellulose film and a TEMPO-oxidized CNF (TEMPO-CNF) film. Cellulose-based films have applications in packaging industry, electronics and diagnostics. The CNF may be produced from mechanical disintegration of bleached hardwood kraft pulp that is commercially available. TEMPO-oxidized cellulose nanofibrils (TEMPO-CNFs) may be produced from dried, bleached softwood kraft pulp. The softwood kraft pulp may be TEMPO-oxidized, where oxidation is mediated by 2,2,6,6-tetramethylpiperidine-1-oxyl (TEMPO) radical. The TEMPO-oxidation may follow a protocol described by Saito et al. in “Homogeneous Suspensions of Individualized Microfibrils from TEMPO-Catalyzed Oxidation of Native Cellulose”, Biomacromolecules, 2006, 7 (6), pp 1687-1691 DOI: 10.1021/bm060154s Publication Date (Web): May 3, 2006. Further details of CNF and TEMPO-CNF film preparation may be referred to in Section 2.1 of Makela et al. referenced below.

A cellulose-based material or cellulose-based material part may be provided as a thin layer i.e. a film. The thickness of the film may be selected at least based on a desired sensitivity for one or more modifications that the cellulose-based material is used to detect and/or to provide a desired transparency of the film. Examples of the modifications comprise at least water, humidity, infrared light, UltraViolet (UV) light, temperature and strain. A suitable thickness may be determined e.g. by conducting calibration measurements of the cellulose-based material or cellulose-based material part for obtaining calibration points for sensing a modification over a range of levels of the modification. For example, if a modification by a specific level of humidity or a range of humidity values should be sensed, the thickness of the cellulose-based material may be selected such that the specific level of humidity or range of humidity values causes a measurable change of a diffraction response of the cellulose-based material. In this way an upper limit for the thickness may be defined. On the other hand, if the change of the cellulose-based material is measurable but gives a maximum result, the measurement based on the cellulose-based material may be saturated, which can be used to detect a lower limit of the thickness of the cellulose-based material. It is between these limits the suitable thickness may be determined according to given application.

In the following description at least some examples are described with reference to cellulose-based film(s). However, it should be noted that the following examples apply more generally to cellulose-based materials that have surface patterns serving for diffraction gratings without being limited to cellulose-based materials formed into films that may have a relatively low thickness, for example a thickness sufficiently low to provide transparency. Accordingly, the thickness of the cellulose-based material may vary between applications of the cellulose-based material. In an example, the cellulose-based material may be provided as a single cellulose-based film or separate cellulose-based films. The single cellulose-based film may be manufactured from separate cellulose-based films by laminating the separate cellulose-based films together, e.g. on top of one another. On the other hand the single cellulose-based film may be manufactured by laminating the separate cellulose-based films onto a common substrate side-by-side. The common substrate may also be a cellulose-based film, but not necessarily.

An apparatus comprising one or more cellulose-based films, or cellulose-based material parts, may output one or more output light patterns, when the apparatus is subjected to light. The output light pattern may be formed based on a surface pattern, e.g. a diffraction grating, of a cellulose-based film, or a cellulose-based material part. Therefore, the cellulose-based film may be referred to an optically active cellulose-based film, or an optically active material part. The light may be received from a Light Emitting Diode (LED), a light bulb, laser, or other form of light source that may have a color that facilitates interaction with the user, for example in a specific environment. The optically active cellulose-based film may be configured to split refract or to split reflect the received light into a plurality of output light patterns. Split refracting the received light comprises that the light received by the optically active cellulose-based film travels at least partly through the optically active cellulose-based film. Then, light output by the optically active cellulose-based film is refracted and split into two or more color components. Split reflecting the received light comprises that the light received by the optically active cellulose-based film is reflected at least partly by the optically active cellulose-based film. Then, light output by the optically active cellulose-based film is reflected and split into two or more color components. An output light pattern of the plurality of output light patterns may be determined on the basis subjecting the optically active cellulose-based film to a modification that causes a change of the properties of the optically active cellulose-based film. Changing the properties of the optically active cellulose-based film controls the split refraction or split reflection, whereby an output light pattern of the optically active cellulose-based film may be determined on the basis of the modification. Accordingly, a modification of the optically active cellulose-based film may be characterized by an output light pattern of the optically active cellulose-based film after the modification and/or a change of the output light pattern of the optically active cellulose-based film in response to the modification.

In the following, examples are described with reference to diffraction gratings as an example of surface patterns. Examples referring to surface patterns apply also to diffraction gratings. A diffraction grating that receives light forms a diffraction response that may form an output light pattern or at least a part of an output light pattern in the examples described herein.

Modification of a cellulose-based material part, e.g. optically active cellulose-based material film, may be determined on the basis of captured data from one or more output light patterns the cellulose-based material part. The output light patterns may comprise one or more diffraction responses formed by one or more diffraction gratings. Examples of the data comprise information indicating shapes, dimensions and/or positions of the diffraction responses. In an example, captured data from one or more preceding output light patterns may be compared with captured data from one or more subsequent output light patterns. A comparison between shapes, dimensions and/or positions of the one or more preceding output light patterns and shapes, dimensions and/or positions of the one or more subsequent output light patterns may be used to determine one or more changes of the output light patterns, whereby at least one modification of the optically active cellulose-based film may be determined, at least based on the differences of the shapes, dimensions and/or positions of the subsequent output light patterns and the preceding output light patterns. In an example, a modification of the optically active cellulose-based film causes a change of a shape, dimensions and/or position of the output light pattern of the optically active cellulose-based film. The change of the shape, dimensions and/or position may be caused by a change of dimensions of a three-dimensional (3D) structure of a surface pattern of the optically active cellulose-based film and/or a change of refractive index of the optically active cellulose-based film. The change of dimensions and/or the refractive index may cause that one or more preceding output light patterns are changed and a comparison between the preceding output light patterns with one or more subsequent output light patterns may be used to determine a modification of the optically active cellulose-based film. Examples of modifications of the optically active cellulose-based film comprise at least that the optically active cellulose-based film is subjected to one of more of water, humidity, infrared light, UltraViolet (UV) light, temperature and strain. It should be noted the infrared light and UV light may be directed from respective sources to the optically active cellulose-based film, which causes the optically active cellulose-based film to heat up and consequently a change of the output light pattern. Intensity of an UV light source and/or an infrared light source may be controlled for achieving a sufficient heating effect on the optically active cellulose-based film. On the other hand the temperature modification may be an increase in the ambient temperature of the optically active cellulose-based film. The increase of ambient temperature may be caused by the sun and/or a change of position of the optically active cellulose-based to a space having a higher ambient temperature. In an example, the optically active cellulose-based film comprises a diffraction grating that is changed, when subjected to a modification, for example water, humidity, infrared light, UltraViolet (UV) light, temperature and strain. Cellulose-based materials may have differences in sensitivity to modifications. Therefore, when more than one cellulose-based film, or at least different cellulose-based materials, each comprising a diffraction grating is subjected to a modification, the modification may be sensed based on an output light pattern formed by the different cellulose-based materials. The output light pattern may be captured for determining a reding indicating the modification.

Examples of output light patterns comprise geometrical patterns. Examples of the geometric patterns comprise at least a circle, a star, a triangle, a rectangle, a pentagon, a hexagon and an octagon. The light may be divided into color components that form the output light pattern. The light may be monochromatic light, e.g. a laser, or the light may comprise more than one color, e.g. white light. A diffraction response formed by a diffraction grating may form at least a part of the output light pattern, for example a part of the geometric form and/or a color component for the output light pattern. In an example, a diffraction response may be a triangle and two diffraction responses may form an output light pattern comprising the triangles positioned top of each other in a star shape. A modification applied to a cellulose-based material, where diffraction gratins are formed, may cause a change of the diffraction gratings. The change of the diffraction gratings is reflected to diffraction responses of the diffraction gratings. In an example, the change of the diffraction gratings may cause that the triangles may be moved apart. When the triangles are moved apart, the shape of the output light pattern may be changed from a star e.g. to a diamond.

A surface pattern of an optically active cellulose-based film may comprise micro/nano scale three-dimensional (3D) structure, e.g. pillars or a grating such as a diffraction grating. Accordingly, dimensions of the structures, such as height, width, depth and diameter, may vary from nanometer scale to micrometer scale. The surface pattern may be configured to split refract or split reflect light into one or more output light patterns, e.g. diffraction responses. Each of the output light pattens may be characterized by one or more dimensions that enable distinguishing the output light patterns from one another. In an example, the surface pattern may be a diffraction grating for forming a diffraction response of received light, whereby the surface pattern may be characterized by grating dimensions, D. The grating dimensions may define a spacing between slits of the diffraction grating. It should be noted that an output light pattern, or a diffraction response, formed by the surface pattern may be differentiated from other output light patterns based on one or more dimensions of the output light pattern. Accordingly, dimensions of the surface pattern, e.g. grating dimensions D, may cause characteristic dimensions, e.g. L, to the output light pattern. For example, an output light pattern may have two or more dimensions, e.g. dimensions Iₓ and I_{y} in directions of axes of a cartesian coordinate system, whereby a combination of the dimensions may characterize each of the output light patterns from other output light patterns. Accordingly, characterizing dimensions of each output light pattern may be presented in the vector L that may have two or more components, e.g. an x-component, i.e. Iₓ, and an y-component, i.e. I_{y}. Alternatively or additionally to characterizing the output light patterns based on the dimensions in directions of the axes of a given coordinate system, vector analysis based on the magnitude |L| and angle (L) of each output light pattern may be used for characterizing the output light patterns from one another.

It should be appreciated that cellulose fibers of the optically active cellulose-based film may be aligned in the same direction, whereby the optically active cellulose-based film is polarization sensitive and birefringent so that refractive index of the optically active cellulose-based film is different to different directions.

A microlens may refer to an optically active cellulose-based material configured to enhance light collimation, dispersion and/or filtering.

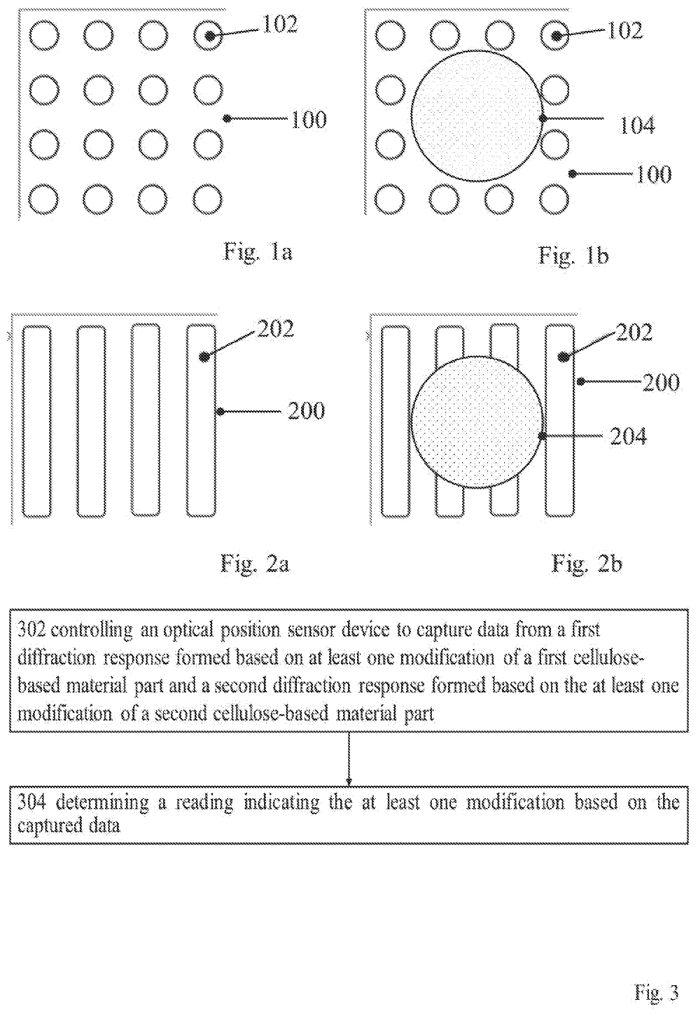

FIG. 1a, FIG. 1b, FIG. 2a, FIG. 2b illustrate surface patterns for optically active cellulose-based films in accordance with at least some embodiments of the present invention. The surface patterns provide that an optically active cellulose-based film may generate an output light pattern, e.g. one or more diffraction responses. In an example, the output light patterns are generated by the surface patterns split refracting or split reflecting received light. In FIG. 1a, FIG. 1b, FIG. 2a and FIG. 2b the surface patterns are illustrated on optically active cellulose-based films 100,200 of which only portions are shown. It should be noted that the optically active cellulose-based films may comprise more than one surface pattern that may be in accordance with the examples described in FIG. 1a, FIG. 1b, FIG. 2a and FIG. 2b. Referring to FIG. 1a and FIG. 1b, a surface pattern of an optically active cellulose-based film 100 comprises micro/nano pillars 102. Referring to FIG. 2a and FIG. 2b, a surface pattern of an optically active cellulose-based film 200 comprises a micro/nano grating 202, i.e. a diffraction grating. Referring to FIG. 1b and FIG. 2b the optically active cellulose-based film comprises one or more microlenses 104, 204. A microlens may be integrated to the optically active cellulose-based film for enhancing light collimation, dispersion and/or filtering.

In an example a microlens 104, 204 may be arranged on one or both sides of the optically active cellulose-based film. When arranged on one side of the optically active cellulose-based film, light entering or leaving the optically active cellulose-based film is collimated or dispersed by the microlens. On the other hand, when arranged on both sides of the optically active cellulose-based film, light entering and light leaving the optically active cellulose-based film may be collimated and/or dispersed by the microlenses.

In an example a microlens 104, 204 may be arranged on the same film with the optically active cellulose-based film and/or a microlens 104, 204 may be arranged on a separate film. When the microlens is arranged on a separate film, the microlens may be laminated on one or both sides of the optically active cellulose-based film.

In an example, absorption of water, e.g. from humidity, into the optically active cellulose-based film 100, 200 causes a change of the size of the surface pattern. In an example, dimensions of the pillars 102 or the diffraction grating 202 may be changed.

In an example an optically active cellulose-based film 100, 200 comprising micro/nano pillars is manufactured using Nanoimprint lithography (NIL) which also may be referred to hot embossing. NIL is a process for replicating micro- and nanoscale patterns. NIL is an efficient method for fabricating large area nano- and micropatterns on various substances, typically thermoplastics. Details of nanoimprint lithography may be referred to in S. Y. Chou, P. R. Krauss, P. J. Renstrom, Nanoimprint lithography J. Vac. Sci. Technol. B, 14 (6) (1996), pp. 4129-4133. Hot embossing is described e.g. in Micro hot embossing of thermoplastic polymers: a review, Linfa Peng et al 2014 J. Micromech. Microeng. 24 013001.

Manufacturing an optically active cellulose-based film 100, 200 using roll-to-roll (R2R) nanoimprint lithography provides a high-throughput for many industrial-scale applications. “Fabrication of micropillars on nanocellulose films using a roll-to-roll nanoimprinting method”, Tapio Makela et al., Microelectronic Engineering, Volume 163, 1 Sep. 2016, Pages 1-6, discloses a method to modify biobased cellulose-based films with thermal roll-to-roll nanoimprinting lithography (R2RNIL) to produce microstructured films. In NIL, a patterned roll and an elastic backing roll are pressed against each other at elevated temperatures, and the pattern is replicated onto the film structure. Height of the replicated pattern are controlled by the temperature, printing speed (contact time to film) and pressure applied in the R2RNIL.

In an example, the optically active cellulose-based film 100, 200 is a polymeric cellulose-based, fibrillated cellulose-based, or fiber cellulose-based film, cellulose nanofibril (CNF), preferably a TEMPO-oxidized cellulose nanofibril (TEMPO-CNF) film. A polymeric cellulose-based film, or also referred to regenerated cellulose-based film, may be cellophane or cellulose acetate, for example.

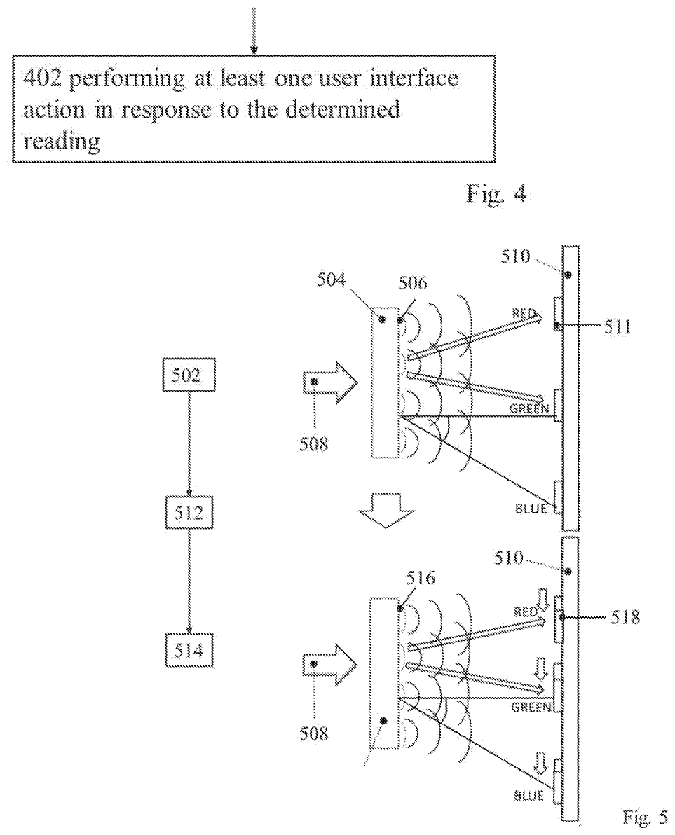

Referring to FIG. 3, there is provided a method for sensing modifications of different cellulose-based materials e.g. cellulose-based films or a single film, comprising different cellulose-based materials that are configured to form diffraction responses. Accordingly, the cellulose-based materials may form cellulose-based material parts. Examples of the cellulose-based material parts comprise at least surface patterns, e.g. diffraction gratings, that are formed of different cellulose-based materials. The method is based on sensitivity differences of the different cellulose-based materials to one or more modifications. A modification may be applied to a cellulose-based material intentionally or unintentionally. An intentional modification of the cellulose-based material may be used for conveying information by using the cellulose-based material as a carrier for the information. The information carried by the cellulose-based material may be encoded based on a type of the modification applied to the cellulose-based material. Examples of the types of modifications comprise at least water, humidity, infrared light, UltraViolet (UV) light, temperature and strain. Additionally, the information carried by the cellulose-based film may be encoded based on a level, or magnitude, of the modification applied to the cellulose-based material. An unintentional modification of the cellulose-based material may be detected in connection with using the cellulose-based material for monitoring a conformance to regulations during a monitoring time period. In an example, the cellulose-based material may be used to monitor a conformance to regulations during a transportation of products, e.g. regarding a transportation temperature. Both the unintentional and intentional modifications may cause changes to dimensions of the cellulose-based materials, which affects optical performance of the cellulose-based materials regarding shapes, dimensions and/or positions of output light patterns of the cellulose-based materials. The method may be performed by at least one processor. The processor may be operatively connected to an optical position sensor device or included to the optical position sensor device.

Phase 302 comprises controlling an optical position sensor device to capture data from a first diffraction response formed based on at least one modification of a first cellulose-based material part and a second diffraction response formed based on the at least one modification of a second cellulose-based material part.

Phase 304 comprises determining a reading indicating the at least one modification based on the captured data. Since at least one of the first part and the second part may be sensitive to the at least one modification, an output light pattern of the cellulose-based material parts may characterize the at least modification, whereby the reading may be determined based on captured data from the diffraction responses, or an output light pattern. Therefore, the captured data facilitates quantifying the at least modification applied to the cellulose-based material parts. Examples of the reading comprise values of physical quantities. A value of a physical quantity may be compensated based on a relationship of the physical quantity to another physical quantity. A value of the physical quantity may be a temperature value, humidity value or a strain value. An example of a compensated value is at least a temperature compensated humidity value. The relationship between physical quantities may be defined by a mathematical formula. Examples of the relationships between physical quantities comprise at least that the physical quantities are directly proportional or inversely proportional with respect to each other.

In an example, phase 304 comprises determining the reading based on the output light pattern, or a change of the output light pattern, formed by the diffraction responses of multiple, i.e. at least two, different cellulose-based materials, in response to subjecting the cellulose-based materials to the at least one modification. In an example, the at least modification may change one or more diffraction responses that form the output light pattern. In an example, the at least one modification may cause a change of a shape, a dimension and/or a position of the one or more diffraction responses. The change may be detected by processing of the captured data, e.g. by image processing of captured digital images.

In an example, phase 304 comprises determining a first parameter based on the data captured from the first diffraction response of the first cellulose-based material part, determining a second parameter based on the data captured from the second diffraction response of the second cellulose-based material part and determining the reading based on a relationship between the first parameter and the second parameter. Accordingly, the reading may be formed by combing the parameters that characterize the modification that has been applied to the cellulose-based material parts based on sensitivity of each of the cellulose-based materials. Examples of the parameters comprise values of physical quantities such as values for measuring water, humidity, infrared light, UltraViolet (UV) light, temperature and strain. The parameters may be determined based on at least shapes, dimensions and/or positions of the diffraction responses. The reading may be a value of a physical quantity or a compensated value of a physical quantity determined based on a relationship of the physical quantity to another physical quantity.

In an example, phase 304 comprises that the reading is determined based on determining a compensated value of the first parameter based on the relationship between the first parameter and the second parameter. Accordingly, the relationship between the parameters facilitates improving the accuracy of the reading. In an example the first parameter is a humidity value and the second parameter is a temperature value and the reading is a temperature compensated humidity value. The relationship between the temperature and humidity may be determined e.g. for the relative humidity in the air.

In an example, phase 304 comprises that the relationship is determined based on calibration measurements. The calibration measurements provide that sensitivities of different cellulose-based material parts to the at least modification may be known for determining the relationship between the parameters determined based on the captured data from the cellulose-based material parts. The determined parameters may be values of related physical quantities, whereby the accuracy of the determined reading may be improved. The calibration measurements may be performed by measuring diffraction responses, or capturing data from the diffraction responses, of the cellulose-based material parts in response to different levels of the at least modification. In an example at least one of the parameters is quantity ‘A’ and at least one of the parameters is quantity ‘B’. The ‘B’ may be dependent on the ‘A’, whereby the ‘A’ and ‘B’ have a relationship. In an example the related physical quantities may comprise temperature and relative humidity of air, where the relative humidity of air may be dependent on the temperature of the air. Accordingly, each part, e.g. the first cellulose-based material part the second cellulose-based material part, may have their respective calibrations to one or more modifications. The calibrations represent sensitivity of the cellulose-based material parts to a given type of modification, whereby the calibrations enable determining the reading indicating the modification. Calibration measurements may be performed for various physical quantities, e.g. values for measuring water, humidity, infrared light, UltraViolet (UV) light, temperature and strain.

In an example, phase 304 comprises that the reading is a temperature compensated humidity value and the temperature compensated humidity value is determined based on a relationship between the first diffraction response and the second diffraction response. The relationship may be determined by making calibration measurements that comprise measuring diffraction responses, or capturing data for determining temperature and humidity values, of the cellulose-based material parts in response to different levels of the temperature and humidity. The calibration measurements may be used to define one or more mathematical formulas that define the relationship.

In an example phase 304 comprises determining the reading based on diffraction grating dimensions of the cellulose-based material parts. The diffraction grating dimensions, D₁ and D₂, may be determined based on the captured data from the diffraction responses of the first cellulose-based material part and the second cellulose-based material part, where D₁ is a grating dimension of a diffraction grating of the first cellulose-based material and D₂ is a grating dimension of a diffraction grating of the second cellulose-based material. The grating dimensions are sensitive to one or more modifications. Examples of the modifications comprise at least water, humidity, infrared light, UltraViolet (UV) light, temperature and strain. Using the examples of the temperature and humidity, the diffraction responses of the first part and the second part may be defined by their respective calibrations for temperature and humidity, as follows:

$$Temperature : {D}_{1} = ax + b , \qquad ( 1 )$$

$$Humidity : {D}_{1} = fy + g , \qquad ( 2 )$$

$$Temperature : {D}_{2} = ix + j , \qquad ( 3 )$$

$$Humidity : {D}_{2} = ky + l , \qquad ( 4 )$$

where x is temperature (° C.) and y is humidity (%), and a,b,f and g are calibration constants of the first part and I, j, k and l are calibration constants of the second part. Then, a modification of the cellulose-based material parts, by temperature x should follow the formulas (1) and (3). On the other hand a modification of the cellulose-based material parts, by humidity y should follow the formulas (2) and (4). It should be appreciated that although the formulas (1) to (4) illustrate a linear relationship between the grating dimension also other mathematical relationships are possible. For example, the mathematical relationship between a diffraction grating dimension and a value for a given modification, e.g. temperature, humidity or strain, may be a first order relationship (linear relationship) or a higher order relationship, for example 2^{nd} order, 3^{rd} order, 4^{th} order or higher relationship. Moreover, the number of calibration constants may be varied. It should be appreciated that, different modifications, e.g. the temperature and humidity illustrated by the formulas (1) to (4), may be uncorrelated. However, if the modifications correlate with each other, in order to determine a reading based on the diffraction grating dimensions of the cellulose-based material parts, each reading, e.g. humidity reading, may need to be calibrated based on more than one reading of another modification, e.g. temperature.

It should be appreciated that a reading for a given modification, e.g. x in the formulas (1) and (3), may be or indicate an amount of the modification in a unit of measurement, e.g. in ° C. On the other hand a reading for a given modification, e.g. y in the formulas (2) and (4), may be a proportional/normalized value, e.g. in %, indicating an amount of a modification in a measurement unit with respect to a reference value that may be given in the same measurement unit.

In an example, phase 302 comprises that the cellulose-based material parts are modified by subjecting the cellulose-based material parts to water. The cellulose-based material parts may be subjected to water e.g. by increasing an ambient humidity of the cellulose-based material parts. The ambient humidity may be increased e.g. by water vapor. When the cellulose-based material parts are subjected to water, the water is absorbed into the cellulose-based material parts, thereby increasing a humidity level of the cellulose-based material parts. In an example, an increased humidity of the cellulose-based material parts causes that dimensions of the surface patterns of the cellulose-based material parts are changed, e.g. the cellulose-based material parts are swollen, whereby the output light pattern formed by the cellulose-based material parts is also changed.

In an example, in phase 302, the cellulose-based material parts may comprise one or more microlenses for light collimation, dispersion and/or filtering out one or more colors of the light received by the surface pattern. The microlenses may be arranged one or both sides of a cellulose-based material part for light collimation, dispersion and/or filtering out one or more colors of the received light.

In an example, phase 302 comprises that the cellulose-based material parts are configured to form a plurality of output light patterns. The output light patterns may comprise diffraction responses that are characteristic to one or more modifications. The data captured from the diffraction responses may comprise at least digital images. The diffraction responses may indicate at least a type of the modification applied to the cellulose-based material parts. Additionally, the diffraction responses may indicate a level, or magnitude of the modification. The output light patterns may be characterized from other output light patterns based on a shape, dimensions and/or a position of the diffraction responses. Characterizing shape, dimensions and/or a position of each output light pattern may be determined from the captured data. The characterizing dimensions may be presented in a vector L. Then, phase 304 may comprise that the reading is determined based on processing the vector L for detecting the type of the modification and additionally a level, or magnitude, of the modification. Accordingly, the reading may indicate at least the type of the modification. However, additionally, the reading may indicate the level, or magnitude, of the modification.

In an example, phase 304 comprises capturing data from the diffraction responses before and after the at least one modification is applied to the cellulose-based material parts. The modification and the level of the modification applied to the cellulose-based material parts may cause a movement and/or a color spectrum widening of the diffraction responses, which may be captured to the data for determining the reading indicating the at least one modification.

In an example, phase 304 comprises that an output light pattern of the cellulose-based material parts corresponds to a humidity level. Accordingly, the cellulose-based material parts may be subjected to a humidity level and the first cellulose-based material part and the second cellulose-based material part may form respective diffraction responses that are characteristic to the humidity level. Different humidity levels may produce different diffraction responses and corresponding output light patterns. Accordingly, the output light patterns may change as function of humidity. Examples of different humidity levels comprise at least from 0% to 100%, preferably from 0% to substantially 70% or at least almost 70% for observing a linear change of output light patterns of the cellulose-based material parts. On the other hand, examples of different humidity levels for applications, where a relatively high change in output light pattern is preferred, e.g. an ON/OFF-sensor for detecting any or at least most modifications of the output light pattern, comprise 70% to 99%. In an example, the diffraction responses may change as function of humidity, when the absorbed water changes dimensions of the surface patterns of the cellulose-based material parts.

In an example, phase 302 comprises that the optical position sensor device is a digital camera, executing a camera application and generating a still image of the cellulose-based material parts located in a field of view of the camera. The camera application may be executed continuously and generating still images. On the other hand, the camera application may be executed discontinuously, e.g. based on triggering of the application e.g. by a timer or other condition. A single image may be sufficient to determine the modification at least when the camera has a sufficiently long exposure time to capture a change of the output light pattern.

In an example, phase 302 comprises that the optical position sensor device is a digital camera, executing a camera application and generating a video clip of the cellulose-based material parts located in a field of view of the camera. The video provides continuous monitoring of the modification such that a time instant of modification may be determined accurately.

Referring to FIG. 4, there is provided a method for sensing modifications of different cellulose-based materials e.g. cellulose-based films or a single film, comprising different cellulose-based materials that are configured to form diffraction responses. The method may be performed by at least one processor. The processor may be operatively connected to a user interface. The method may be performed after phase 304 of FIG. 3.

In an example, phase 402 comprises performing at least one user interface action in response to the determined reading. The user interface action provides interaction with the user via the user interface, whereby the user may be notified about the determined reading indicating the at least one modification. In this way the user does not necessarily have to observe the modification and/or a change of output light patterns but thanks to the user interface action the user can still be informed, when the reading determined based on captured data satisfies at least one condition. It should be appreciated that the user interface provides notifying the user about the reading particularly, when the user does not have knowledge about how to interpret the output light patterns and/or when the output light patterns or their changes are not visible to human eye. For example, the user interface action may notify the user if the reading meets an alarm threshold. The alarm threshold may be e.g. a value of a physical quantity, or a compensated value of a physical quantity such as a value for measuring water, humidity, infrared light, UltraViolet (UV) light, temperature and strain. The alarm threshold may be set by the user or be pre-configured based on a type of modification. In an example a duration of the user interface action may be limited in time, the user interface action may be semi-permanent or the user interface action may be permanent. In an example a user interface action limited in time may be a sound that is played for a relatively short time period after the cellulose-based material parts have as been modified. In an example a semi-permanent user interface action may be a sound that is stopped after the user enters an acknowledgement of the sound on the user interface. In an example a permanent user interface action may be a sound that is played continuously. Although the foregoing uses a sound as an example, also other user interface actions may be used alternatively or additionally. Further examples of the user interface actions comprise displaying information and/or turning on a light. Examples of the displayed information comprise user interface elements that may comprise graphics or text or a combination thereof. In an example, the reading may be displayed and highlighted by a color, e.g. red color. A light may be a Light Emitting Diode (LED), a light bulb, laser, or other form of light source that may have a color that facilitates interaction with the user, for example in a specific environment of the apparatus. Examples of user interfaces for implementing a user interface action comprise input devices and output devices such as display and computer peripherals. A touch screen may serve both for user input and user output.

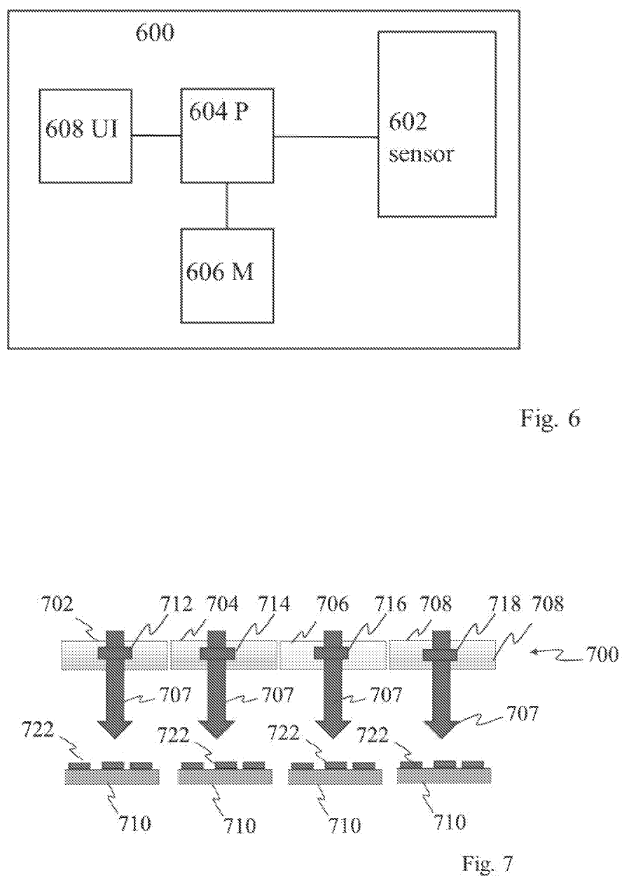

FIG. 5 illustrates change of a surface pattern in accordance with at least some embodiments of the present invention. In FIG. 5, a cellulose-based film comprising a single surface pattern, or diffraction grating, is illustrated. However, it is helpful in understanding examples, where a cellulose-based film has more than one part, for example to, three, four or more parts, e.g. diffraction gratings, for forming diffraction responses, or where more than one cellulose-based films comprising diffraction gratings for forming diffraction gratings are provided. Phase 502 comprises exposing an optically active cellulose-based film 504 comprising a surface pattern 506 to white light 508 that travels through the optically active cellulose-based film. The surface pattern split refracts the white light to an output light pattern 511 on a detector 510. Phase 512 comprises applying one or more modifications to the optically active cellulose-based film by subjecting the optically active cellulose-based film to water, humidity, infrared light, UltraViolet (UV) light, temperature and strain. In this way the surface pattern 506 may be changed and a new surface pattern 516 may be generated. Phase 514 comprises exposing the optically active cellulose-based film 504 comprising the new surface pattern 516 to white light 508 that travels through the optically active cellulose-based film. The new surface pattern split refracts the white light to a new output light pattern 518 on the detector 510. Accordingly, applying one or more modifications to the optically active cellulose-based film causes a change of the output light pattern 511.

In an example the output light pattern 511,518 comprises separate areas of different colors on the detector. The colors may comprise red, green and blue light. After the optically active cellulose-based film is modified the output light pattern 511 is changed. In accordance with the arrows next to the detector 510, modifying the optically active cellulose-based film may cause the output light pattern 511 to be moved downwards and thereby a new output light pattern 518 may be generated. It should be appreciated that the detector may comprise a planar surface but also a non-planar surface is feasible. Accordingly, the output light pattern may be moved on the surface of the detector at least in directions, where the surface of the detector extends. It should be appreciated that an image or a video captured by a digital camera may serve as the detector.

Although the change of surface pattern is illustrated in FIG. 5 in connection with split refraction it should be appreciated in accordance with at least some embodiments, one or more output light patterns may be caused by the optically active cellulose-based film split reflecting light.

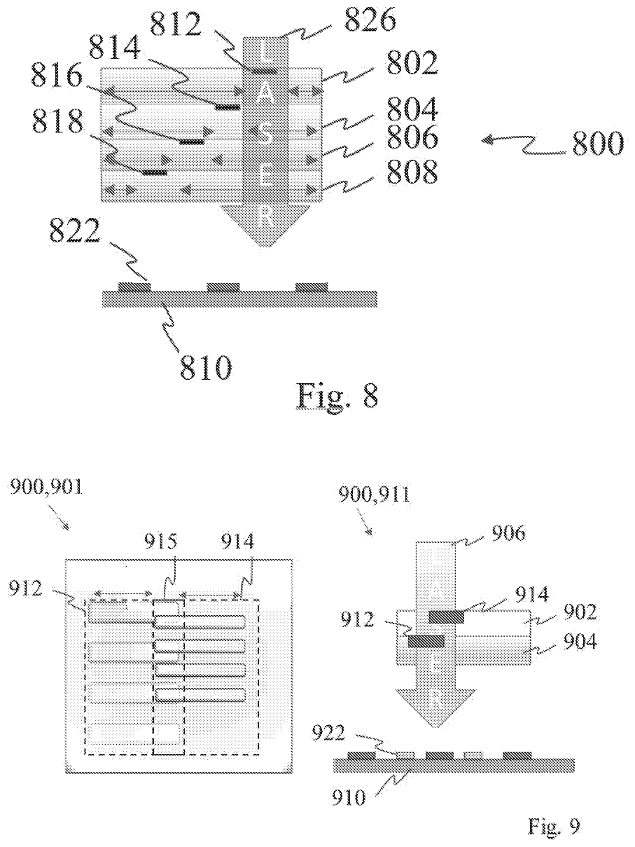

FIG. 6 illustrates a block diagram of an arrangement in accordance with at least some embodiments of the present invention. The arrangement comprises an optical position sensor device 602 for capturing data, a processor 604, a memory 606 and a user interface 608 that may be connected operatively to cause one or more functionalities described herein. Connections between the optical position sensor device, processor, memory and user interface may be implemented by electrical conductors e.g. on a circuit board.

The data captured by the optical position sensor device 602 may comprise at least information indicating shapes, dimensions and/or positions of diffraction responses. The data provides detecting one or more parameters from diffraction responses of the cellulose-based material parts. In an example the data may comprise one or more images or video. The images and video may be digital images and video that may be generated e.g. by the optical position sensor device being a digital camera.

In an example, the processor 604 is configured to control the optical position sensor device to capture data from a first diffraction response formed based on at least one modification of a first cellulose-based material part and a second diffraction response formed based on the at least one modification of a second cellulose-based material part, and determine a reading indicating the at least one modification based on the captured data.

In an example the arrangement comprises a user interface 608. The processor is configured to control the user interface to perform at least one user interface action in response to the determined reading.

The memory 606 may be a separate memory. On the other hand, the memory may be included to the processor and/or the optical position sensor device. Moreover, the arrangement may comprise a separate memory and memory included to the processor and/or the optical position sensor device.

Examples of the optical position sensor devices 602 comprise devices capable of generating data for detecting positions of optical signals, comprising at least a digital camera, a photocell and a light intensity sensor. The optical position sensor devices may be also referred to matrix detectors or row detectors which have detector elements in two-dimensional array/matrix or in one dimensional line/row. A field of view of the optical position sensor device may be an area of sensitivity of the optical position sensor device, where the optical position sensor device may capture data. The cellulose-based material parts or diffraction responses may be positioned within the field of view for determining the reading.

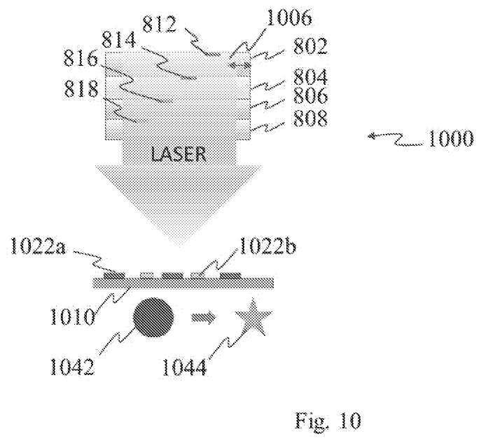

FIGS. 7 to 10 illustrate examples of apparatuses 700, 800, 900, 1000 comprising cellulose-based films comprising at least two parts for forming diffraction responses. Accordingly, the apparatuses comprise a first cellulose-based material part for forming a first diffraction response and a second cellulose-based material part for forming a second diffraction response, wherein the first cellulose-based material part and the second cellulose-based material part are of different cellulose-based materials, whereby in response to the at least one modification applied to the apparatus, the apparatus is configured to form, based on at least one of the first diffraction response and the second diffraction response, at least one output light pattern for characterizing the at least modification. In an example the cellulose-based materials are arranged on top of one another or side-by-side with each other. In an example the cellulose-based materials comprise polymeric cellulose, fibrillated cellulose, and/or fiber cellulose, cellulose nanofibril, CNF, preferably TEMPO-oxidized cellulose nanofibril, TEMPO-CNF. In an example, the cellulose-based materials may be arranged on top of one another such that cellulose acetate (CA) is on top and below the CA are cellophane, CNF and TEMPO-CNF in the respective order. In another example, the cellulose-based materials may be arranged on top of one another such that CNF is on top and below the CNF is TEMPO-CNF.

In an example, the cellulose-based material parts of the apparatuses 700, 800, 900, 1000 comprise surface patterns for forming the diffraction responses. The diffraction responses may be formed on a detector. The surface patterns may be diffraction gratings. The surface patterns may be provided on different types of cellulose-based films, whereby the diffraction gratings may have different sensitivities to modifications. When the cellulose-based films are subjected to one or more modifications, the diffraction gratings may form output light patterns 722, 822, 922, 1022a,1022b in accordance to described with FIG. 5. FIG. 7 illustrates cellulose-based films arranged side-by-side with respect to each other and with non-overlapping diffraction gratings and FIGS. 8-10 illustrate cellulose-based films arranged on top of one another. When the cellulose-based films are arranged side-by-side with respect to each other with non-overlapping diffraction gratings, the diffraction gratings form diffraction responses independently from one another. On the other hand, when the cellulose-based films are arranged on top of one another, the diffraction gratings may be non-overlapping in accordance with FIG. 8 and FIG. 10 or at least partially overlapping in accordance with FIG. 9. The cellulose-based films that are arranged on top of one another may be laminated together to form a single film or the cellulose-based films may be separate films. When the cellulose-based films are arranged on top of one another and particularly, when the diffraction gratings are at least partially overlapping, at least a part of the light received by a diffraction grating may be a diffraction response of another diffraction grating, i.e. the light received by the diffraction grating from another diffraction grating. Therefore, the diffraction grating may form a diffraction response that is dependent on a diffraction response of the other diffraction grating. If the diffraction gratings are not totally overlapping, the diffraction grating may receive light both directly from a light source and additionally from another diffraction grating. In this way, an output light pattern of the apparatus may be formed based on light travelling through two or more diffraction gratings.

Referring to FIG. 7, cellulose-based films 702,704,706,708 are arranged side-by-side with respect each other. The cellulose-based films may be different types of cellulose-based films. Examples of the cellulose-base films comprise at least polymeric cellulose-based film, fibrillated cellulose-based film, and/or fiber cellulose-based film, cellulose nanofibril, CNF, preferably a TEMPO-oxidized cellulose nanofibril, TEMPO-CNF, film. Each of the cellulose-based films comprise a diffraction grating 712,714,716,718. Light 707 received by the cellulose-based film travels through each of the diffraction gratings that split-reflect and/or split refract the light independently from one another, thereby forming an output light pattern on a detector 710. The output light pattern 722 may be formed by a combination of diffraction responses of the diffraction gratings on the detector.

Referring to FIG. 8, cellulose-based films 802,804,806,808 are arranged on top of one another. The cellulose-based films may be different types of cellulose-based films. Examples of the cellulose-base films comprise at least polymeric cellulose-based film, fibrillated cellulose-based film, and/or fiber cellulose-based film, cellulose nanofibril, CNF, preferably a TEMPO-oxidized cellulose nanofibril, TEMPO-CNF, film. Each of the cellulose-based films comprise a diffraction grating 812,814,816,818. Light 826 may be received at each of the diffraction gratings that split-reflect and/or split refract the light independently from one another, thereby forming an output light pattern on a detector 810. Each of the diffraction gratings may be directed a separate light beam (according to the illustration) or a light beam may be directed to a part, or all, of the diffraction gratings. The output light pattern 822 may be formed by a combination of diffraction responses of the diffraction gratings on the detector. At least a part of the diffraction gratings 814,816,818 are positioned under one or more cellulose-based films 804,806,808 on top, whereby the at least part of the diffraction gratings may receive light through one or more cellulose-based films 804,806,808. The cellulose-based films 802,804,806,808 may comprise areas without diffractions gratings, i.e. non-patterned portions. The non-patterned portions are illustrated in the FIG. 8 by double-headed arrows. The cellulose-based films may be aligned with respect to each other such that the diffraction grating of the cellulose-based film on top of one or more further cellulose-based films is positioned on top of the non-patterned portions of the one or more further cellulose-based films. ON the other hand, a diffraction grating of a cellulose-based film under one or more cellulose-based films is positioned under the non-patterned portions of the cellulose-based films located atop. Therefore, light 826 received by the cellulose-based films travels through each of the diffraction gratings that form diffraction gratings independently from one another, thereby forming an output light pattern 822 on a detector 810. The output light pattern may be formed by a combination of diffraction responses of the diffraction gratings.

Referring to FIG. 9, cellulose-based films 902,904 are arranged on top of one another. The cellulose-based films are illustrated by a top view 901 and a side view 911. Examples of the cellulose-base films comprise at least polymeric cellulose-based film, fibrillated cellulose-based film, and/or fiber cellulose-based film, cellulose nanofibril, CNF, preferably a TEMPO-oxidized cellulose nanofibril, TEMPO-CNF, film. Each of the cellulose-based films comprise a diffraction grating 912,914. The cellulose-based films are positioned on top of one another such that diffraction gratings of the cellulose-based films are at least partially overlapping, whereby light 906 may travel through overlapping portions 915 of the diffraction gratings. The top view shows the diffraction grating 912 located on the cellulose-based film 904 under the cellulose-based film 902 positioned on top. An output light pattern 922 may be formed based on light travelling through the overlapping portions of the diffraction gratings that form a diffraction response on a detector 910. If one or more of the diffraction gratings are non-overlapping with other diffraction gratings or if one or more of the diffraction gratings comprise one or more portions that are non-overlapping with other diffraction gratings, the output light pattern may be formed based on both light travelling through the overlapping diffraction gratings and light travelling through the non-overlapping portions or non-overlapping diffraction gratings. The non-overlapping portions of the diffraction gratings are illustrated by double-headed arrows.

FIG. 10 illustrates an example of a change of output light pattern of cellulosed films arranged on top of one another. The example is described with reference to similar items described with FIG. 8. The diffraction gratings 812,814,816,818 are illuminated by directing a single light beam 1006 to all the diffraction gratings. In an example, the light may be monochromatic light, e.g. a laser beam. Before a modification is applied to any of the cellulose-based films, an output light pattern 1022a may be formed by a combination of diffraction responses of the diffraction gratings on a detector 1010. After the modification has been applied, at least a part of the diffraction gratings of the cellulose-based films or all of the diffraction gratings of the cellulose-based films have been modified, whereby the diffraction gratings form a new output light pattern 1022b on the detector. In an example, the output light pattern 1022a before the modification may be a geometric form, for example a circle 1042, and after the modification has been applied the new output light pattern may be another geometric form, e.g. a star 1044. The geometric forms enable e.g. detecting a number of corners and/or a number of sides of the geometric form. Alternatively or additionally, the output light pattern before the modification may have a specific color and after the modification the color is changed. Therefore, eh output light pattern before and after the modification may be captured for determining reading indicating the modification applied to the cellulose-based film.

In an example in accordance with at least some embodiments, a processor is configured to control a digital camera to capture at least one image and/or a video from, a first diffraction response formed based on at least one modification of a first cellulose-based material part and a second diffraction response formed based on the at least one modification of a second cellulose-based material part, and the processor is configured to determine a reading indicating the at least one modification based on the captured data.

A memory may refer to a computer readable medium that may be non-transitory. The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, arrangement, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialized circuits such as field programmable gate arrays FPGA, application specify circuits ASIC, signal processing devices and other devices. References to computer readable program code means, computer program, computer instructions, computer code etc. should be understood to express software for a programmable processor firmware such as the programmable content of a hardware device as instructions for a processor or configured or configuration settings for a fixed function device, gate array, programmable logic device, etc.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, arrangement, systems, techniques or methods described herein may be implemented in, as non-limiting examples, hardware, software, firmware, special purpose circuits or logic, general purpose hardware or controller or other computing devices, or some combination thereof.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1. An apparatus comprising a first cellulose-based material part for forming a first diffraction response and a second cellulose-based material part for forming a second diffraction response, wherein the first cellulose-based material part and the second cellulose-based material part are of different cellulose-based materials, whereby in response to the at least one modification applied to the apparatus, the apparatus is configured to form, based on at least one of the first diffraction response and the second diffraction response, at least one output light pattern for characterizing the at least modification.

2. The apparatus according to claim 1, wherein the first cellulose-based material part and the second cellulose-based material part are arranged on top of one another or side-by-side with respect to each other.

3. The apparatus according to claim 1, wherein the first cellulose-based material part and the second cellulose-based material part are at least partially overlapping or non-overlapping.

4. The apparatus according to claim 1, wherein the at least one modification is at least one of a water, humidity, infrared light, UltraViolet (UV) light, temperature and strain.

5. The apparatus according to claim 1, wherein the first cellulose-based material part and the second cellulose-based material part are different materials from materials comprising a polymeric cellulose, fibrillated cellulose, and/or fiber cellulose, cellulose nanofibril, CNF, preferably a TEMPO-oxidized cellulose nanofibril, TEMPO-CNF.

6. The apparatus according to claim 1, wherein the first cellulose-based material part and the second cellulose-based material part have different sensitivities to the at least one modification.

7. An arrangement comprising an optical position sensor device for capturing data and a processor connected to the optical position sensor device, wherein the processor is configured to:
control the optical position sensor device to capture data from a first diffraction response formed based on at least one modification of a first cellulose-based material part and a second diffraction response formed based on the at least one modification of a second cellulose-based material part; and
determine a reading indicating the at least one modification based on the captured data.

8. The arrangement according to claim 7, comprising:
determining a first parameter based on the data captured from the first diffraction response of the first cellulose-based material part;
determining a second parameter based on the data captured from the second diffraction response of the second cellulose-based material part; and
determining the reading based on a relationship between the first parameter and the second parameter.

9. The arrangement according to claim 8, comprising:
determining a compensated value of the first parameter based on the relationship between the first parameter and the second parameter.

10. The arrangement according to claim 8, wherein the relationship is determined based on calibration measurements.

11. The arrangement according to claim 7, comprising:
determining the reading based on diffraction grating dimensions of the cellulose-based material parts.

12. The arrangement according to claim 7, wherein the at least one modification is at least one of a water, humidity, infrared light, UltraViolet (UV) light, temperature and strain.

13. The arrangement according to claim 7, wherein the optical position sensor device is a digital camera.

14. The arrangement according to claim 7, wherein the first cellulose-based material part and the second cellulose-based material part are different materials from materials comprising film is a polymeric cellulose, fibrillated cellulose, and/or fiber cellulose, cellulose nanofibril, CNF, preferably a TEMPO-oxidized cellulose nanofibril, TEMPO-CNF.

15. A method comprising:
controlling, by a processor, an optical position sensor device to capture data from a first diffraction response formed based on at least one modification of a first cellulose-based material part and a second diffraction response formed based on the at least one modification of a second cellulose-based material part; and
determining, by the processor, a reading indicating the at least one modification based on the captured data.

16. A computer program comprising instructions for causing an apparatus connected to an optical position sensor device to perform at least the following:
controlling, by the apparatus, the optical position sensor device to capture data from a first diffraction response formed based on at least one modification of a first cellulose-based material part and a second diffraction response formed based on the at least one modification of a second
cellulose-based material part; and
determining, by the apparatus, a reading indicating the at least one modification based on the captured data.
